(19) United States
(12) Patent Application Publication
(10) Pub. No.: US 2009/0049991 A1
(43) Pub. Date: Feb. 26, 2009

(54) Barbecue gridiron

(76) Inventor: Cheng-Hsing Chien, Fongshan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/892,183

(22) Filed: Aug. 21, 2007

(51) Int. Cl. A47J 37/07; A47J 37/06

(52) U.S. Cl. 99/357; 99/401

(57) ABSTRACT

A barbecue gridiron includes an upper board part, and a lower board part; the upper and the lower board parts have many meshes thereon; the upper and the lower board parts are secured together to constitute a mesh-like barbecue gridiron member; the meshes of the upper board part each face a corresponding mesh of the lower board part; the upper and the lower board parts are connected at outer peripheries as well as those portions that are around the meshes such that a hermetic holding space exists between the upper and the lower board parts; water is contained in the hermetic holding space; when food materials are being roasted on the barbecue gridiron over a fire, water will circulate in the hermetic holding space to help prevent temperature of the mesh-like barbecue gridiron member from getting too high, thus preventing the food materials from being scorched to be unpalatable.

### BACKGROUND OF THE INVENTION

1. Field of the Invention

The present invention relates to a barbecue gridiron, more particularly one, which has water contained and circulated in a hermetic holding space thereof to help prevent temperature of the gridiron from getting too high when food materials are being roasted on the gridiron over a fire; thus, the food materials can't be scorched before they become properly cooked.

2. Brief Description of the Prior Art

In barbecue, people usually put food materials such as meats on a mesh-like frame (gridiron) positioned over a fire produced by means of burning charcoals; thus, the food materials are roasted with the fire.

While food materials are being roasted on the mesh-like frame, they will be coated with various sauces, and turned over frequently so as to be evenly and properly cooked without being scorched. However, food materials still can be scorched to be unpalatable because such mesh-like frames are usually made of metals, which have relatively good heat conductivity. Therefore, it isn't ideal to use such metallic mesh-like frames in barbecue.

### SUMMARY OF THE INVENTION

It is a main object of the present invention to provide an improvement on a barbecue gridiron to overcome the above problems.

A barbecue gridiron according to an embodiment of the present invention includes upper and lower board parts, which have many meshes thereon, and which are secured together to constitute a mesh-like barbecue gridiron member. The meshes of the upper board part each face a corresponding mesh of the lower board part. The upper and the lower board parts are connected at outer peripheries as well as those portions that are around the meshes such that a hermetic holding space exists between the upper and the lower board parts. The gridiron further comprises connecting pipes, which are connected to two sides of the mesh-like barbecue gridiron member respectively, and communicate with the hermetic holding space. A pump is connected to the connecting pipes through coupling pipes to pump water into the hermetic holding space. When food materials are being roasted on the barbecue gridiron over a fire, water will be circulated in the hermetic holding space so as to help to prevent temperature of the mesh-like barbecue gridiron member from getting too high. Consequently, the food materials are prevented from being scorched to be unpalatable, and they can be properly roasted to be more delicious.

### BRIEF DESCRIPTION OF THE DRAWINGS

The present invention will be better understood by referring to the accompanying drawings, wherein:

FIG. 1 is a perspective view of a board member of the barbecue gridiron of the present invention,

FIG. 2 is a perspective view of two board members of the barbecue gridiron of the present invention under assembly,

FIG. 3 is a lateral sectional view of the barbecue gridiron of the present invention,

FIG. 4 is a horizontal sectional view of the barbecue gridiron of the present invention in use, and

FIG. 5 is a front view of the barbecue gridiron of the present invention in use.

### DETAILED DESCRIPTION OF THE PREFERRED EMBODIMENTS

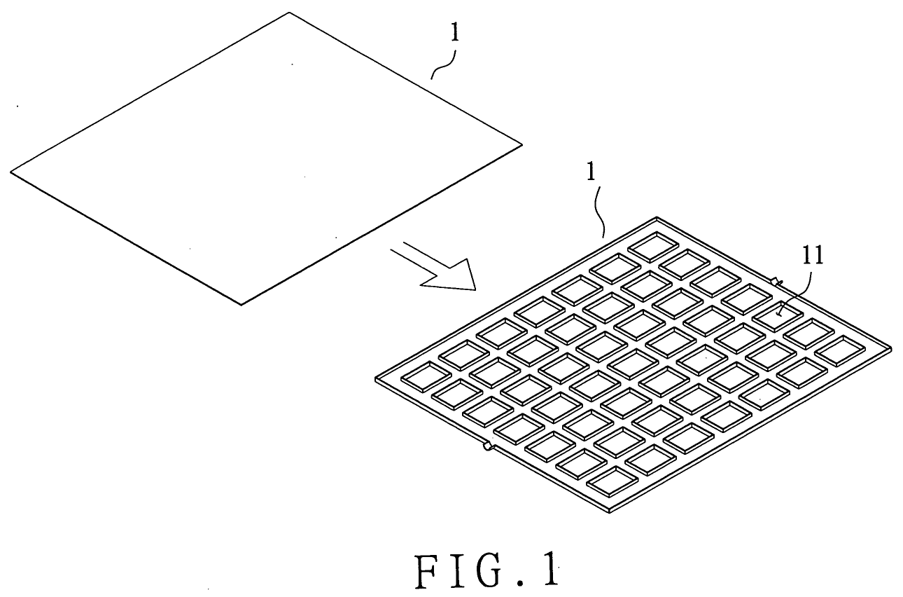

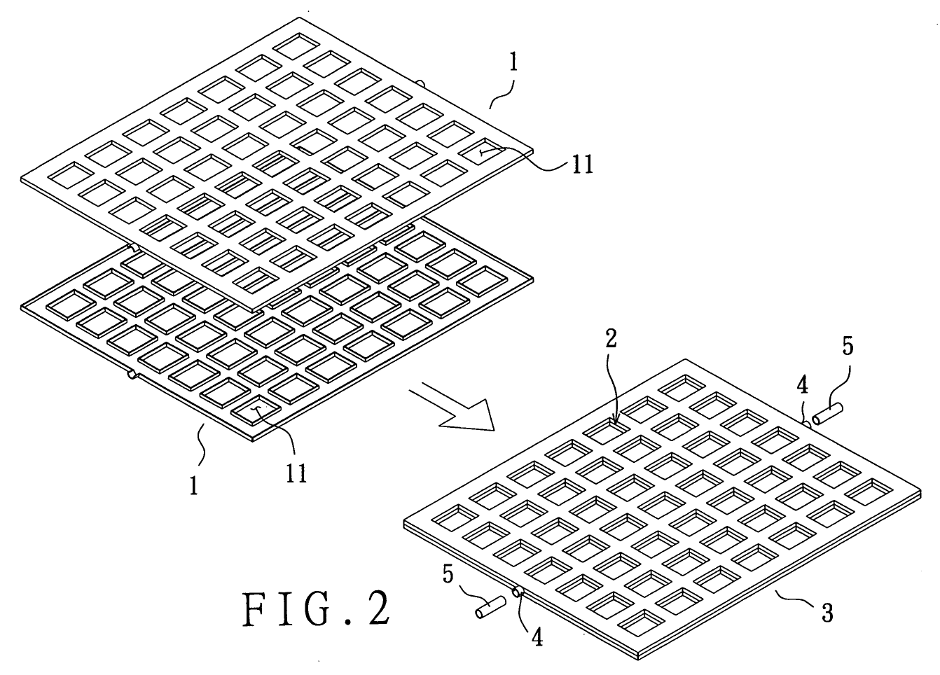

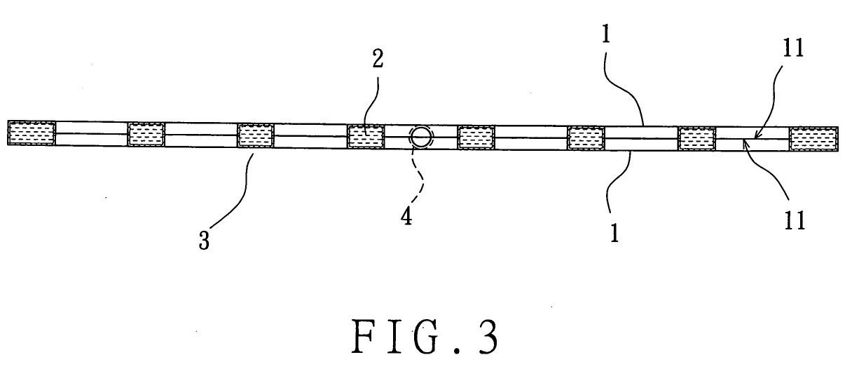

Referring to FIG. 1 to FIG. 4, a preferred embodiment of a barbecue gridiron of the present invention includes an upper board part 1, and a lower board part 1, which is secured on a bottom of the upper board part 1 to form a mesh-like barbecue gridiron member 3, as shown in FIG. 2. The upper and the lower board parts 1 are formed with many meshes 11, as shown in FIG. 1, by means of a proper method, e.g. punching, forging, and casting. The meshes 11 of the upper board part 1 each face a corresponding said mesh 11 of the lower board part 1. The upper and the lower board parts 1 are connected at outer peripheries as well as those portions thereof that are around the meshes 11 by means of laser welding such that a hermetic holding space 2 comes into existence between the upper and the lower board parts 1, i.e. in the mesh-like barbecue gridiron member 3.

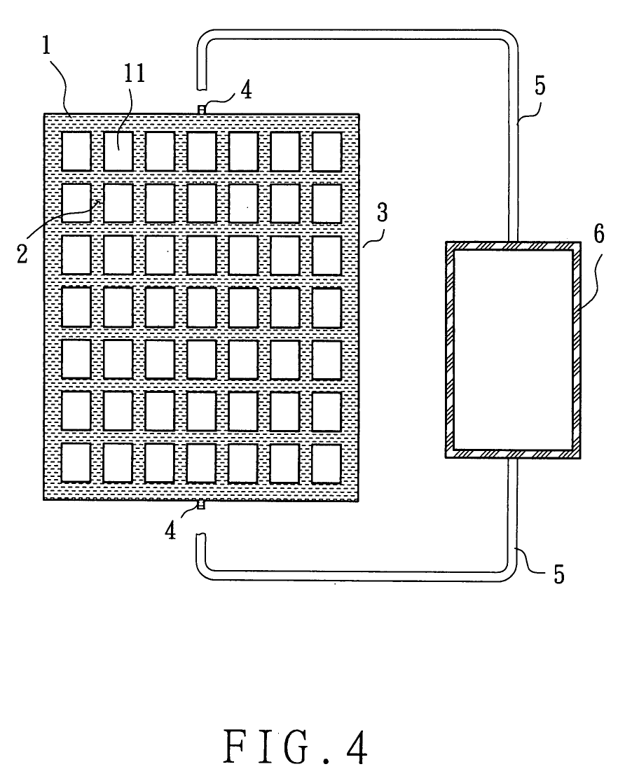

The barbecue gridiron further comprises two connecting pipes 4, which are securely joined to two sides of the gridiron member 3, and communicate with the hermetic holding space 2, shown in FIG. 2. Furthermore, referring to FIG. 4, a pump 6 is connected to the connecting pipes 4 by means of coupling pipes 5. Therefore, water can be pumped into the hermetic holding space 2 of the mesh-like barbecue gridiron member 3 through the coupling pipes 5 and the connecting pipes 4 by means of the pump 6; when food materials are being broiled on the mesh-like barbecue gridiron member 3 over a fire, water in the hermetic holding space 2 will circulate so as to help to reduce temperature, thus preventing temperature of the mesh-like barbecue gridiron member 3 from becoming too high. Consequently, the food materials can be prevented from being scorched before they become cooked.

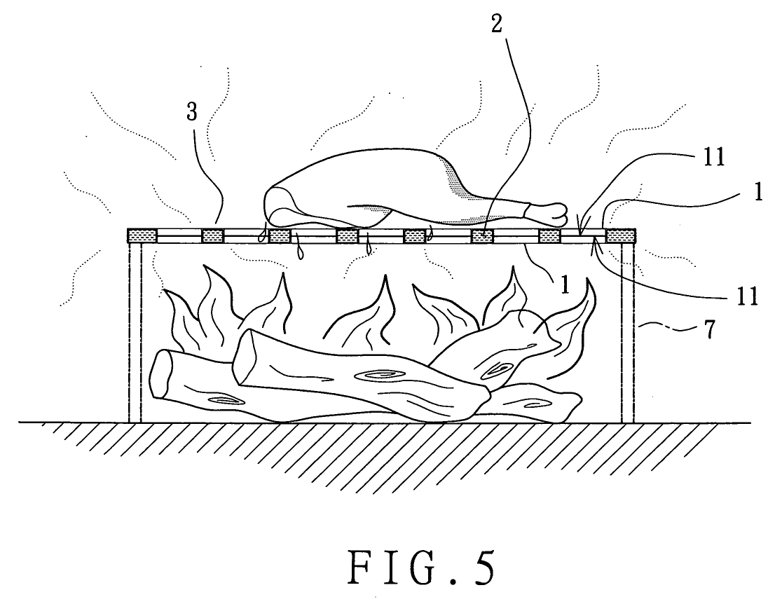

Referring to FIG. 4 as well as FIG. 5, which shows the barbecue gridiron member 3 of the present invention being positioned over a fire for food materials to be roasted on, in use, first the mesh-like barbecue gridiron member 3 is supported above fuels such as charcoal by means of a stand 7, and the pump 6 is connected to the connecting pipes 4 through the coupling pipes 5. Next, water is pumped into and circulated in the hermetic holding space 2 in the barbecue gridiron member 3 by means of the pump 6. Afterward, food materials are positioned on the mesh-like barbecue gridiron member 3, and the fuels are burned to produce fire to roast the food materials. When the food materials are being roasted on the mesh-like barbecue gridiron member 3 over a fire, water will be circulated in the hermetic holding space 2 so as to help to prevent temperature of the barbecue gridiron member 3 from becoming too high. Consequently, the food materials are prevented from being scorched before they become cooked. And, the food materials will be relatively palatable because they are properly roasted without being scorched.

From the above description, it can be seen that the barbecue gridiron of the present invention has an advantage: the barbecue gridiron comprises two board parts with meshes, which are joined together to form a hermetic holding space between them, and water is held in the hermetic holding space; when food materials are being roasted on the barbecue gridiron over a fire, water will circulate in the hermetic holding space so as to help to prevent temperature of the mesh-like barbecue gridiron member from becoming too high. Consequently, the food materials are prevented from being scorched to be unpalatable, and they can be properly roasted to be relatively delicious.

What is claimed is:

1. A barbecue gridiron, comprising
an upper board part formed with a plurality of meshes; and
a lower board part formed with a plurality of meshes, the upper and the lower board parts being secured together to constitute a mesh-like barbecue gridiron member; the meshes of the upper board part each facing a corresponding said mesh of the lower board part; the upper and the lower board parts being connected at outer peripheries as well as those portions that are around the meshes such that a hermetic holding space exists between the upper and the lower board parts; and
a kind of liquid, which is contained in the hermetic holding space so as to circulate in the hermetic holding space.

2. The barbecue gridiron as claimed in claim 1, wherein the upper and the lower board parts are formed with the meshes by means of punching.

3. The barbecue gridiron as claimed in claim 1, wherein the upper and the lower board parts are formed with the meshes by means of forging.

4. The barbecue gridiron as claimed in claim 1, wherein the upper and the lower board parts are formed with the meshes by means of casting.

5. The barbecue gridiron as claimed in claim 1, wherein laser welding is used to join the outer peripheries of the upper and the lower board parts and those portions that are around the meshes of the upper and the lower board parts.

6. The barbecue gridiron as claimed in claim 1 further comprising connecting pipes, which are connected to two sides of the mesh-like barbecue gridiron member respectively, and communicate with the hermetic holding space; the connecting pipes being connected to a pump through coupling pipes, which pump is provided to pump the liquid into the hermetic holding space in order for the liquid to circulate in the hermetic holding space.
